(19) United States
(12) Patent Application Publication
(10) Pub. No.: US 2012/0143467 A1
(43) Pub. Date: Jun. 7, 2012

(54) ISG RESTART CONTROL DEVICE AND METHOD OF ISG VEHICLE

(75) Inventors: Jiyong YU, Pocheon-si (KR); Sejun KIM, Seoul (KR); Chongah GWON, Hwaseong-si (KR); Junghwan BANG, Hwaseong-si (KR)

(73) Assignee: Hyundai Motor Company, Seoul (KR)

(21) Appl. No.: 13/306,466

(22) Filed: Nov. 29, 2011

(30) Foreign Application Priority Data
Dec. 1, 2010 (KR) 10-2010-0121683

(51) Int. Cl. F02D 45/00

(52) U.S. Cl. 701/102

(57) ABSTRACT

An ISG restart control device of an ISG vehicle may include a seatbelt state detecting unit that detects fastening/unfastening state of a seatbelt, a door state detecting unit that detects opening/closing state of a door, a brake pedal state detecting unit that detects an operation state of a brake pedal, and a control unit that forcibly idle-stops or restarts an engine by receiving a driving state information of the vehicle and restricts restarting of the engine in accordance with the fastening/unfastening of the seatbelt, the opening/closing of the door, and the operation state of the brake pedal which may be detected by the seatbelt state detecting unit, the door state detecting unit, and the brake pedal state detecting unit, in the restarting.

### CROSS-REFERENCE TO RELATED APPLICATIONS

The present application claims priority to Korean Patent Application Number 10-2010-0121683 filed Dec. 1, 2010, the entire contents of which application is incorporated herein for all purposes by this reference.

### BACKGROUND OF THE INVENTION

1. Field of the Invention

The present invention relates to an ISG vehicle equipped with an ISG (Idle Stop and Go) system, and particularly, to an ISG restart control device and an ISG restart control method of an ISG vehicle which determine whether to restart the engine by checking the state of the vehicle when the engine is ISG-restarted by the ISG system.

2. Description of Related Art

Recently, technologies for improving fuel efficiency to reduce CO2 have been developed in various ways, and the ISG system is a system that stops the engine when a vehicle stops and automatically starts the engine when the vehicle starts.

The ISG system allows normal traveling by automatically idle-stopping the engine under predetermined conditions while receiving information, such as the speed of the vehicle, the revolution speed of the engine, and the temperature of the cooling water, and then automatically restarting (Go) the engine when restart is required by the driver's intention and the conditions of the vehicle itself.

The condition for entering the idle-stop in the ISG system is a state with the engine sufficiently warmed up, that is, a stop state where the vehicle speed is not detected with the cooling water maintained at a predetermined temperature or more, and when a predetermined time passes after the brake pedal is operated, the engine is stopped to increase fuel efficiency and reduce emission.

Further, when the driver's intention of starting the vehicle, for example, operating the acceleration pedal, releasing the brake pedal, or operating the clutch pedal, with the engine idle-stopped, the engine is started for normal traveling. It is possible to achieve an effect of an increase in fuel efficiency of about 5 to 15% in the vehicle equipped with the ISG system.

Although the ISG system has been developed to preferentially improve fuel efficiency of a vehicle, it is necessary to consider the safety as much as possible.

Therefore, restart by the ISG is restricted even if the condition for restarting the engine is satisfied, when a seatbelt is unfastened or a door is open with the engine idle-stopped in the ISG vehicle.

FIG. 1 is an operational flowchart showing an ISG method of an ISG vehicle.

When an ISG idle-stop condition is satisfied while a vehicle travels (S11), the engine is idle-stopped by the ISG (S12). When the driving state of the vehicle satisfies a restart condition (S14), with seatbelts fastened and doors closed (S13), the engine is restarted by the ISG (S15). Meanwhile, when a seatbelt is not fastened or a door is not closed (S13), determination of ISG restart is held (S16) and the engine keeps stopped.

However, when restart is restricted without reservation in accordance with the state of seatbelts or doors, as in the related art, boosting pressure of the brake is removed or the engine is not restarted even if the vehicle moves on a down hill, which causes a dangerous situation.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to provide an ISG restart control device and an ISG restart control method of an ISG vehicle which determine and control whether to restrict restarting of an engine in consideration of other states of the vehicle even if a seatbelt is not fastened or a door is open during ISG idle-stop.

In an aspect of the present invention, an ISG restart control device of an ISG vehicle, may include a seatbelt state detecting unit that detects fastening/unfastening state of a seatbelt, a door state detecting unit that detects opening/closing state of a door, a brake pedal state detecting unit that detects an operation state of a brake pedal, and a control unit that forcibly idle-stops or restarts an engine by receiving a driving state information of the vehicle and restricts restarting of the engine in accordance with the fastening/unfastening of the seatbelt, the opening/closing of the door, and the operation state of the brake pedal which are detected by the seatbelt state detecting unit, the door state detecting unit, and the brake pedal state detecting unit, in the restarting.

The ISG restart control device may further include a display unit that is controlled by the control unit to output a notification of making a driver turn a start key.

The control unit restarts the engine when the seatbelt is not fastened or the door is not closed and an operation angle of the brake pedal exceeds a critical angle, wherein a display unit is controlled by the control unit to output a notification of making a driver turn a start key when the operation angle of the brake pedal does not exceeds the critical angle.

In another aspect of the present invention, an ISG restart control method of an ISG vehicle may include a step of sensing a state of a seatbelt and a state of a door when an engine is idle-stopped by an ISG and an engine restart condition is satisfied, a step of sensing an operation state of a brake pedal when the seatbelt is not fastened or the door is not closed in the step of sensing the state of the seatbelt and the state of the door, a step of restarting the engine when the seatbelt is not fastened or the door is not closed in the step of sensing the state of the seatbelt and the state of the door and an operation angle of the brake pedal exceeds a critical angle in the step of sensing the operation state of the brake pedal, and a step of restricting restart of the engine and maintaining an idle-stop state when the operation angle of the brake pedal does not exceed the critical angle in the step of sensing the operation state of the brake pedal.

The engine is restarted when the seatbelt is fastened, the door is closed, and a forceable restart condition is satisfied in the step of sensing the state of the seatbelt and the state of the door.

The step of restricting restart of the engine and maintaining idle-stop state may further include outputting a notification of making a driver turn a start key when the operation angle of the brake pedal does not exceeds the critical angle.

According to exemplary embodiments of the present invention, it is possible to improve safety of a vehicle while maintaining the effect of improving fuel efficiency by determining whether to restrict restarting of an engine in consideration of not only a seatbelt state and a door state, but a brake pedal state, during ISG restart in an ISG vehicle.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is an operational flowchart showing an ISG method of an ISG vehicle of the related art.

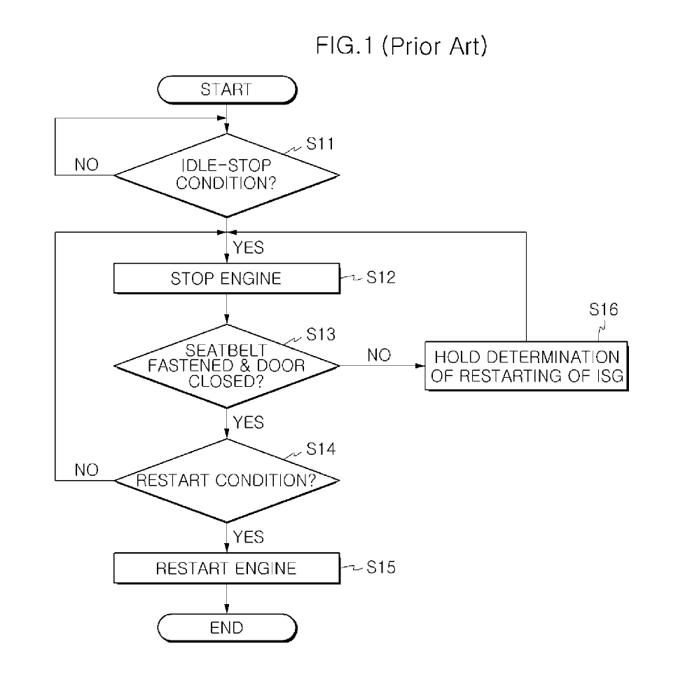

FIG. 2 is a block diagram showing the configuration of an ISG restart control device of an ISG vehicle according to an exemplary embodiment of the present invention.

FIG. 3 is an operational flowchart showing an ISG restart control method of an ISG vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereafter, ISG restart control device and method for an ISG vehicle according to an exemplary embodiment of the present invention are described in detail with reference to the accompanying drawings.

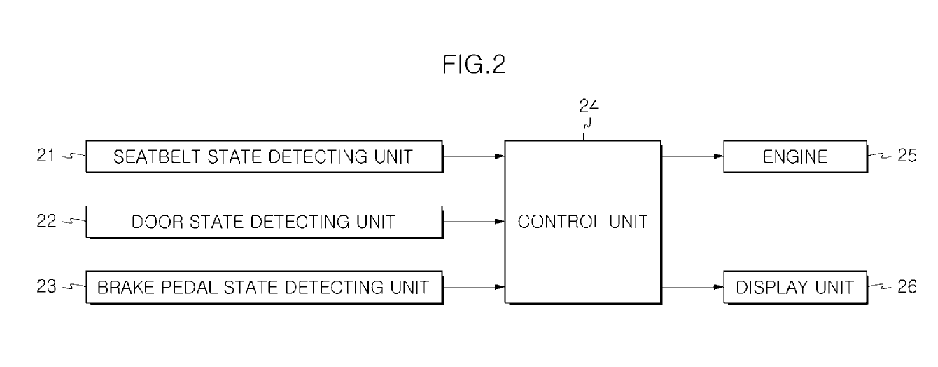

FIG. 2 is a block diagram showing the configuration of an ISG restart control device of an ISG vehicle according to an exemplary embodiment of the present invention.

An ISG restart device according to an exemplary embodiment of the present invention includes a seatbelt state detecting unit 21 that detects fastening/unfastening of seatbelts, a door state detecting unit 22 that detects opening/closing of doors, a brake pedal state detecting unit 23 that detects the operation state of a brake pedal, and a control unit 24 that forcibly idle-stops or restarts an engine 25 by receiving the driving state information of a vehicle and restricts restarting of the engine in accordance with fastening/unfastening of seatbelts, opening/closing of doors, and operation of the brake pedal which are detected by seatbelt state detecting unit 21, door state detecting unit 22, and brake pedal state detecting unit 23, in the restarting.

The ISG restart control device further includes a display unit 26 that is controlled by control unit 24 to output a notification of making a driver turn the start key.

Control unit 24 holds and restricts restarting of the engine and outputs a notification such that a driver starts the engine using a start key on display unit 26, even if the engine restart condition is satisfied when a seatbelt is unfastened, a door is open, and a brake pedal is not operated at a predetermined angle or more. However, the engine is restarted because safety is ensured even if the engine is forcibly restarted, when the brake pedal is operated at a predetermined angle or more, when a seatbelt is unfastened and a door is open.

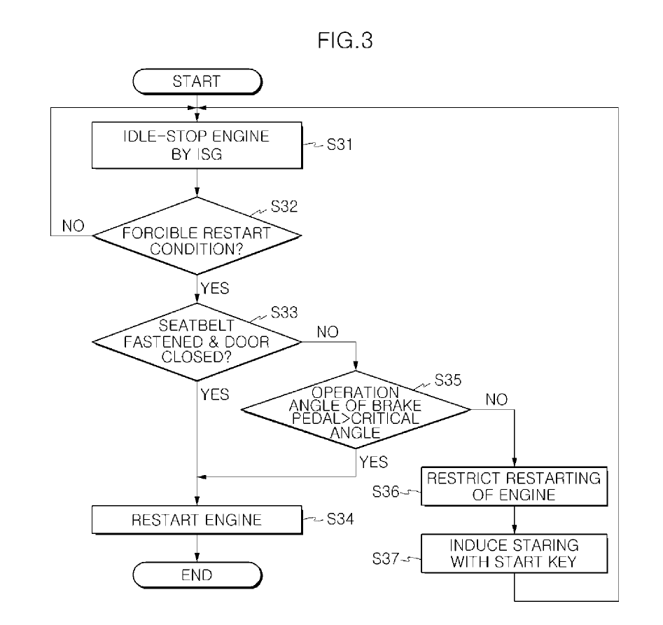

FIG. 3 is an operational flowchart showing an ISG restart control method of an ISG vehicle according to an exemplary embodiment of the present invention.

The states of seatbelts and doors are sensed when the engine is idle-stopped by the ISG (S31) and the forcible restart condition is satisfied (S32). When the seatbelt is fastened and the doors are closed (S33), the engine is restarted (S34).

When the seatbelt is not fastened or the door is not closed (S33), the operation state of the brake pedal is sensed. When the operation angle of the brake pedal exceeds a critical angle (S35), the process proceeds to step S34 and the engine is restarted. When the operation angle of the brake pedal does not exceed the critical angle (S35), restarting of the engine is restricted (S36) and a notification of making driver start the engine with the start key (S37).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An ISG restart control device of an ISG vehicle, comprising:
a seatbelt state detecting unit that detects fastening/unfastening state of a seatbelt;
a door state detecting unit that detects opening/closing state of a door;
a brake pedal state detecting unit that detects an operation state of a brake pedal; and
a control unit that forcibly idle-stops or restarts an engine by receiving a driving state information of the vehicle and restricts restarting of the engine in accordance with the fastening/unfastening of the seatbelt, the opening/closing of the door, and the operation state of the brake pedal which are detected by the seatbelt state detecting unit, the door state detecting unit, and the brake pedal state detecting unit, in the restarting.

2. The ISG restart control device as defined in claim 1, further comprising a display unit that is controlled by the control unit to output a notification of making a driver turn a start key.

3. The ISG restart control device as defined in claim 1, wherein the control unit restarts the engine when the seatbelt is not fastened or the door is not closed and an operation angle of the brake pedal exceeds a critical angle.

4. The ISG restart control device as defined in claim 3, wherein a display unit is controlled by the control unit to output a notification of making a driver turn a start key when the operation angle of the brake pedal does not exceeds the critical angle.

5. An ISG restart control method of an ISG vehicle, comprising:
a step of sensing a state of a seatbelt and a state of a door when an engine is idle-stopped by an ISG and an engine restart condition is satisfied;
a step of sensing an operation state of a brake pedal when the seatbelt is not fastened or the door is not closed in the step of sensing the state of the seatbelt and the state of the door;
a step of restarting the engine when the seatbelt is not fastened or the door is not closed in the step of sensing the state of the seatbelt and the state of the door and an operation angle of the brake pedal exceeds a critical angle in the step of sensing the operation state of the brake pedal; and
a step of restricting restart of the engine and maintaining an idle-stop state when the operation angle of the brake pedal does not exceed the critical angle in the step of sensing the operation state of the brake pedal.

6. The ISG restart control method as defined in claim 5, wherein the engine is restarted when the seatbelt is fastened, the door is closed, and a forceable restart condition is satisfied in the step of sensing the state of the seatbelt and the state of the door.

7. The ISG restart control method as defined in claim 5, wherein the step of restricting restart of the engine and maintaining idle-stop state further includes outputting a notification of making a driver turn a start key when the operation angle of the brake pedal does not exceeds the critical angle.
